(19) United States
(12) Patent Application Publication
(10) Pub. No.: US 2015/0351878 A1
(43) Pub. Date: Dec. 10, 2015

(54) Dental Tool for Customizing Implants, System and Methods Thereof

(71) Applicant: Iulian HONIG, Bucharest (RO)

(72) Inventor: IULIAN HONIG, BUCHAREST (RO)

(21) Appl. No.: 14/760,471

(22) PCT Filed: Jan. 13, 2014
(86) PCT No.: PCT/IL2014/050036

§ 371 Date: Jul. 11, 2015

Related U.S. Application Data
(60) Provisional application No. 61/751,895, filed on Jan. 13, 2013.

(51) Int. Cl. A61C 8/00; A61C 13/00

(52) U.S. Cl. CPC A61C 8/0089; A61C 13/0006

(57) ABSTRACT

A device, system and method providing a dental tool (100) and a guiding member (108) for customizing at least a portion of a member of a dental implant system by way of milling and/or filing.

### FIELD OF THE INVENTION

This disclosed subject matter relates to dental implants in general and in particular to a device for adjusting and/or manipulating portions of dental implant assembly about its various parts.

### BACKGROUND OF THE INVENTION

In its simplest form dental implant assembly and/or system are known in the art and typically include a dental anchor that is securely inserted into the patient jawbone, replacing the root, a restoration that replaces the tooth crown and an abutment and/or pivot member that interface both the anchor and restoration. Commonly, in the art, the abutment is affixed to the anchor through a fixation screw also known as an abutment screw.

A multitude of prefabricated abutments and implant systems of various designs are offered to clinicians in an effort to provide clinicians with necessary means to successfully restore edentulous patients.

In order to be successful, the implant anchor and all restorative devices associated therewith, should meet specific functional, biological and esthetic requirements. These requirements may be achieved if the restorative implant system, and/or devices used on the implants, adhere to major biomechanical principles, including: Preservation of implant structure; Passive retention and Passive support; Resistance form; Structural durability of the restoration; Marginal integrity and emerging profiling (marginal compliance); Retrievability and Retrofitting; Individuality; Preservation of the perio-implant tissues. Therefore, for a successful implant procedure to take place, the above mentioned biomechanical principles must be met.

A number of factors in the design of the abutments determine if a restoration can adhere to the previously mentioned biomechanical principles in order to achieve the desired functional, biological and esthetic requirements. For example, the abutment's connection to the anchor platforms has an effect on the abutment's position and stability.

Prior art abutments and/or restorative systems and/or portions thereof do not meet the above mentioned bio mechanical principals, leading to major drawbacks in the quality of the restoration. Due to these limitations, clinicians are forced to compromise the functional, biologic and esthetic requirements of the restoration. Such compromises may for example result in or lead to: shortening the survivability and/or viability of the implant, irreparable damage to host tissue; damaged implant structures, the requirement of laborious and prolong multi-stage and multiple surgical procedures, reduce access for maintenance of the host tissues, makes it very difficult and often impossible to maintain an implant's assembly elements and substantially increase costs.

### SUMMARY OF THE INVENTION

Prior dental implant systems generate major drawbacks by providing unstable connection platforms and limited designs of abutments which restrict the abutment's shape, level of angulation and provide limited directionality control relative to the patient, and therefore cannot be customized to the patient. Prior art dental implant systems substantially limit clinician's options to properly position an abutment (and the restoration mounted thereon) relative to other abutments and/or teeth of same and/or opposite jaw. Prior art dental implant systems do not provide an abutment assembly that may be adjusted and/or customized with respect to individual morphology, specific clinical situation of the patient and according the biomechanical principles.

Similarly, current abutments do not allow for, parallel alignment between abutments and/or associated prepared teeth, and/or other teeth involved in the rehabilitation process. Proper shape, adequate position and/or parallel alignment are essential for providing the restoration with the attributes necessary to achieve the prosthodontics requirements according the biomechanical principles.

In order to enable rehabilitation prior restoration systems, abutments must have their position and/or alignment improved by additional adjustments (by milling and/or casting), resulting in another major drawback. The adjustments made by milling and/or casting causes the disruption of the shape and geometry of the prior art abutment and implant assembly, specifically, the formation of undercuts and/or irregularities leads to the reduction of abutment to restoration contact surface (therein leading to poor retention) and incomplete seating of restoration (leading to lower durability of restoration and percolation of fluids).

Similarly, prior art abutments do not allow for the finish line to be individually adjusted in relation with the bone level, soft tissues, abutment's axis, and the occlusal plane, thus impeding the achievement of an adequate smooth well positioned finish line with proper width to receive the encountered forces and closely fit with restoration's margins.

The unstable connection systems and the lack of or inadequate finish line of prior systems causes gaps between the different implant system parts (for example between the anchor and abutment; restoration margins and abutment finish line) that lead to: percolation and retention of fluids and pathogens into implant-restoration structure about the vicinity of host tissue; irritation, inflammation and damage to perio-implant tissue; bad odor; bad taste; and damage to implant's elements and/or structures. Furthermore, prior systems lack a finish line altogether, resulting in weak, over contoured restoration margins which intrude perio-implant tissues, increasing food and plaque retention. Prior art systems provide limited options of standardized prefabricated pre-positioned finish lines, thus defining standard transmucosal abutment portion (abutment collar) which does not and cannot take into account various clinical situations. Moreover, a prefabricated finish line provided with prior art abutments does not provide for the improvement of the marginal seal, the formation of a healthy biologic width, and the required direction imperative to provide passive support to encountering forces. Embodiments of the presently disclosed invention overcome the deficiencies of the prior art dental implant systems.

The presently disclosed subject matter relates to dental tools and methods of their use, that facilitate customizing and/or adjusting and/or manipulating a dental implant system or any of its members and/or elements and/or constituents, for example an adjustable implant abutment assembly or any elements thereof.

The adjustable and/or customizable dental implant system referenced herein and throughout this application is described in a co-owned and pending PCT Application No. PCT/IB2012/053829 the contents of which are incorporated herein by reference as if fully set forth herein.

The present invention overcomes the deficiencies of the background art by providing tools and their method of use that facilitate customizing a prosthodontic implant system, about at least one of its members or parts.

Most preferably the dental tools of the present invention provide for positioning and configuring the prosthodontic implant system according to an individual's morphology and clinical situation, while allowing practitioners to fulfill the aforementioned biomechanical principles, including: Preservation of implant structure; Passive Retention and passive Support; Resistance form; Structural durability of the restoration; Marginal integrity (marginal compliance); Retrievability; Preservation of the period-implant tissues; and Individuality, therein most preferably achieving the prosthodontic requirements.

Optional embodiments of the present invention provide, tools for customizing and/or adjusting and/or manipulating at least one of an implant system about any member or portion thereof and/or an implant post and/or an adjustable abutment pivot, off the shelf abutment, implant anchor, tissue level anchor, bone level anchor, the like or any combination thereof; for properly positioning and/or shaping in accordance with the prosthodontics requirements, the specific clinical situation and in respect to the biomechanical principles. Most preferably such proper positioning provides the appropriate alignment of the abutment about surrounding teeth, tissues, the occlusal plane and additional abutments. Most preferably proper positioning of an abutment for example includes but is not limited to an abutment's desired angle, direction and vertical dimension, the like or any combination thereof.

Optionally the tools of the present invention may be utilized for customizing and/or milling and/or filing any state of the art implant systems, implant post, abutment, and implant anchors, tissue level implant, bone level implant or the like implant system member.

Optionally and most preferably, the tools of the present invention may be utilized to customize an implant system member and/or abutment assembly to form a correctly positioned abutment assembly and/or post.

Optionally and preferably, tools of the present invention facilitate positioning of an implant abutment member according individual morphology and clinical situation.

Optionally and preferably dedicated tools may be utilized to customize an implant system and/or abutment assembly to form a finish line, which may be individually adjusted in relation with the bone level, soft tissues, abutment's axis, and the occlusal plane. The finish line may be defined and/or positioned with optional dedicated tool. Optionally the finish line may be positioned according to any clinical situation. Most preferably the finish line is configured to be just about parallel with the occlusal plane and/or other finish lines and substantially perpendicular about abutment axis. Most preferably such dedicated tools may provide the achievement of a smooth well positioned finish line with proper width to receive the encountered forces and closely fit with restoration's margins

Most preferably the tools of the present invention allow an abutment assembly to be adjusted so as to assume a position that is substantially perpendicular to the occlusal plane and just about parallel with adjacent and/or other abutments and/or teeth. Thus essentially, the tools facilitate defining only one path of insertion and retrievability that is substantially parallel to the axis of the abutment and/or abutments.

The aforementioned positioning and/or parallel alignment of abutments and/or teeth in addition with the aforementioned position of the finish line provides the restoration with complete sitting, and allow the restoration margins to lie and closely fit against the finish line, synergistically increasing the, passivity of the retention, the passivity of the support and the resistance form, and determine that the implant structures, the implant elements and perio-implant tissues are not subject to harmful impact such as tension, sheer force, compression or torque

By allowing the creation of one path of insertion and retrievability and a well-defined finish line most preferably the tools according to the present invention, provide for retrievability and retrofitting of a restoration. One path of insertion and retrievability preferably provides for improving the continuing maintenance of the implant, for example including but not limited to, replacement of the abutment or other prosthodontic elements, performance of additional surgical procedures, exercising hygienic evaluation, allow for the adjustment of the restoration in case an implant is lost, the like or any combination thereof.

A preferred embodiment of the present invention provides a cutting tool adept to cut, file, mill, grind, excise, surface, level, score, slice, route, size, shape, the like or any combination thereof in order to customize and/or adjust at least one or more member of a dental implant system and/or an abutment assembly.

Optionally the operation of cutting tool according to optional embodiments of the present invention may be facilitated with a guiding member. Optionally and preferably guiding member provides to facilitate proper positioning of the tool relative to a member of abutment assembly and/or implant system that is being adjusted.

Optionally guiding member may be provided in the form of an elongated cylindrical rod, that may be associated with a member of implant system and/or abutment assembly about a first end and/or associated with the tool about a second end, for example within a lumen of the cutting tool.

Optionally tool according to optional embodiments may further comprise a fluid exchange channel that may be provided for ventilation and/or cooling the tool during its use. Optionally such a fluid exchange channel may be utilized to provide for fluid exchange about the working surface and/or edge during use. Optionally fluid exchange channel may be provided about the external surface, internal (luminal) surface, or within the tools wall as a dedicated channel. Optionally a fluid exchange channel may be provided about any portion of the tool for example including but not limited to handle, body, and/or body. Optionally fluid exchange channel may provide for fluid exchange by delivering and/or removing a flowing fluid from a working surface and/or edge. For example fluid exchange channel may be provided in the form of an irrigation channel to deliver a flowing fluid in the form of a liquid to the working surface so as to cool the surface while using tool 100. Optionally fluid exchange channel may be utilized to suction the working surface during use, for example evacuating air and/or debris during use of the tools so as to preferably maintain a clear and cool working surface.

Optionally the milling and/or grinding device may be utilized chair-side clinical setting and/or in a laboratory setting. Optionally and preferably during chair-side clinical setting use the device according to the present invention may be used in-situ, for example to mill and/or customize an dental implant and/or an abutment at the implantation site.

An optional embodiment of the present invention provides a dental tool provided for milling and/or filing portions of a dental implant system, the device having at least one working surface, the device comprising: a head portion having a surface defining a working surface, the working surface is coated with at least one abrasive material, the surface having a central bore; a tool body portion that is substantially a hollow tube having a central lumen, the central lumen is continuous with the central bore and characterized in that the lumen is configured to receive and house a guiding member; handle portion extending from the body portion provided to facilitate rotating device and the at least one working surface.

Optionally at least one of the body portion and the head portion may be adapted to assume any shape, size, length, diameter, so as to receive at least a portion of one member of a dental implant system through head portion's central bore and body portion central lumen.

Optionally the head portion may be provided from optional shape selected from the group for example including but not limited to discoid, conic, cylindrical, ring, circular, spheroid, semicircular, concentric disc, layered disc, or the like. Preferably the head portion comprises a central bore and/or recess and/or defines a lumen.

Optionally the head portion and the body portion may be provided with the same geometric dimensions therein forming a single fluid continuous body having a central lumen.

Optionally the tool may be provided from a single unitary piece.

Optionally the tool may be assembled from three individual portions that are coupled with one another, including at least one of a handle portion, a body portion and a head portion to form a single unitary continuous milling tool. Optionally and preferably each portion is securely coupled with one another utilizing a one to one coupler or a male to female coupler.

Optionally the tool may be assembled from at a handle portion and at least one of a body portion and head portion.

Optionally the tool handle portion and the body portion may form a single piece that may be coupled to optional head portions.

An optional embodiment of the present invention provides a kit comprising at least two or more milling devices units and/or portion thereof according to embodiment of the present invention. For example a kit may comprise one unitary universal tool, and at least two of each a handle portion, body portion, and head portion that may be securely coupled with one another to form various tools configurations.

Within the context of this application the term adjustment is to refer to any manipulation or change and/or customization to a given implant structure or member thereof for example including but not limited to changing, tilting, height adjustment, milling, grinding, filing, cutting, shaping, forming, bending or the like.

Optionally adjustments may be made with tools, conventional tools and/or dedicated proprietary tools.

Within the context of this application the term abutment and abutment assembly may be used interchangeably.

Within the context of this application the term pivot and abutment pivot and post assembly may be used interchangeably.

Within the context of this application the term occlusal end refers to that portion of the abutment and/or abutment member positioned or directed toward the coronary portion of a tooth.

Within the context of this application the term apical end refers to that portion of the abutment and/or abutment member positioned and/or directed toward the apex of the implant anchor, for example toward the root of a tooth.

Within the context of this application the term prosthodontic requirements refers to the biologic requirement, aesthetic requirement and functional requirements that adhere to the biomechanical principles most preferably to ensuring a proper restoration outcome with respect to the individual's morphology and/or clinical situation.

Within the context of this application the term angle refers to the angle assumed by the abutment by way of customization and/or adjustment, with respect to and/or in relation to the occlusal plane, implant's anchor axis and/or mounting member and/or alveolar bone and/or adjacent teeth, abutments, restorations, on the same and/or opposite jaw.

Within the context of this application the term direction refers the direction assumed by the abutment by way of customization and/or adjustment, wherein the direction is defined by the projection of the abutment within any angle along the 360 degrees of the occlusal plane.

Within the context of this application the term position refers to the spatial disposition of the abutment, abutment assembly or members thereof, for example including but not limited to the interface member, finish line, post, pivot occlusal portion or the like. Optionally and preferably the position may be assumed by way of customization and/or adjustment, derived and/or depicted by the angle, direction, and distance between adjacent anatomical structures for example including but not limited to tongue, lips, additional abutments, abutment assembly members, teeth or the like of same or opposite jaws.

Although the specification and figures describe the present invention with respect to an adjustable dental abutment assembly, embodiments of the present invention may be equally utilized with any state of the art dental implant systems. For example cutting tool of the present invention may be utilized on a state of art dental implant abutment and/or post and is not limited to the dental abutment described in co-owned and co-pending PCT/IB2012/053829.

Unless otherwise defined, all technical and scientific terms used herein have the same meaning as commonly understood by one of ordinary skill in the art to which this invention belongs. The materials, methods, and examples provided herein are illustrative only and not intended to be limiting.

Importantly, this Summary may not be reflective of or correlate to the inventions protected by the claims in this or continuation/divisional applications hereof. Even where this Summary is reflective of or correlates to the inventions protected by the claims hereof, this Summary may not be exhaustive of the scope of the present inventions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIG. 1 is sectional view of a dental implant system placing a prosthodontic restoration within a jaw, showing the final product after implantation is complete with the prosthodontic restoration;

FIG. 2A-B show varying views of a dental implant system comprising an adjustable abutment assembly, that may be adjusted and/or manipulated with the tools according to optional embodiments of the present invention; FIG. 2A is an exploded view of an abutment assembly; FIG. 2B is an assembled view of the abutment assembly following adjustments;

FIGS. 3A-C show various views of a schematic illustration of use of an optional cutting and/or adjustment tool system according to optional embodiments of the present invention;

FIGS. 4A-C show various views of a schematic illustration of an optional cutting and/or adjustment tool according to an optional embodiment of the present invention;

FIGS. 5A-D show various views of a schematic illustration of an optional cutting and/or adjustment tool according to an optional embodiment of the present invention;

FIGS. 6A-D show various views of a schematic illustration of an optional cutting and/or adjustment tool according to an optional embodiment of the present invention;

FIG. 7A-E show schematic illustrations of optional guiding members for facilitating the use of the cutting tool according to an optional embodiment of the present invention;

FIGS. 8A-C show various views of a schematic illustration of an optional cutting and/or adjustment tool according to an optional embodiment of the present invention; and

FIG. 9 shows a flowchart of a method for using tools according to optional embodiments of the present invention.

### DESCRIPTION OF THE PREFERRED EMBODIMENTS

The principles and operation of the present invention may be better understood with reference to the drawings and the accompanying description. The following figure reference labels are used throughout the description to refer to similarly functioning components are used throughout the specification herein below.

| No. # | Description |
|---|---|
| 5 | prosthodontic restoration; |
| 5a | mounting bore; |
| 10 | abutment assembly; |
| 11 | abutment; |
| 12 | abutment pivot; |
| 12a | pivot projection; |
| 13 | engageable portion; |
| 14 | adjustment portion; |
| 15 | stabilizing portion; |
| 16 | pivot mounting member/portion; |
| 17 | screw head interface; |
| 19 | screw thread; |
| 30 | dental implant system; |
| 32 | conventional implant anchor; |
| 32c | anchor crestal portion; |
| 33 | screw thread; |
| 34 | screw thread; |
| 37 | opening; |
| 40 | interface member; |
| 46a | flange; |
| 50 | sleeve; |
| 50c | sleeve lumen; |
| 54 | outer sleeve member; |
| 55 | jawbone; |
| 56 | residual teeth; |
| 70 | locking nut; |
| 100 | Cutting Tool; |
| 100c | Tool coupling handle; |
| 100h | Tool conic head; |
| 100e | tooling surface edge; |
| 100s | tooling surface; |
| 100w | Tool Wide head; |
| 102 | head portion; |
| 102a | receiving bore/recess; |
| 102e | head portion edge; |
| 102c | concentric head portion; |
| 102i | outer portion; |
| 102o | inner portion; |
| 104 | body portion; |
| 104L | body portion lumen; |
| 104s | body portion internal surface; |
| 106 | handle/machining portion; |
| 106c | handle coupler; |
| 107 | Fluid exchange channel; |
| 108 | guiding member; |
| 108a | first end; |
| 108b | second end; |
| 108j | guide member joint; |

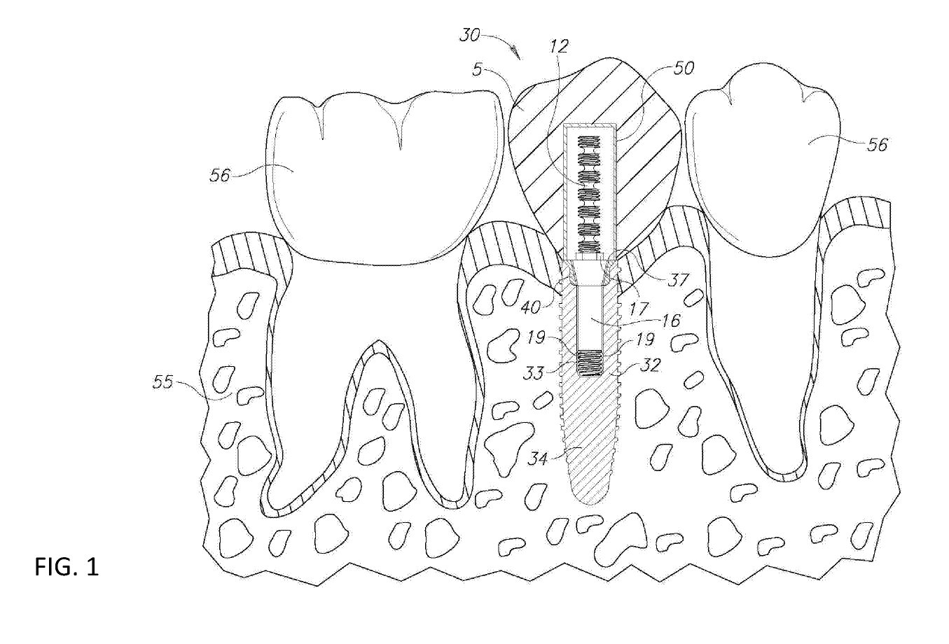

FIG. 1 is an illustrative diagram showing the final product of an exemplary dental implant procedure. The dental implant procedure is utilized to replace a tooth over an edentulous area. The dental implant assembly generally comprises an anchor 32, to replace the tooth root portion, a restoration 5, in place of the tooth body and/or enamel, and an abutment or abutment assembly that is utilized to interface and/or couple restoration 5 and anchor 32, for example as shown.

More specifically, FIG. 1 is a side sectional view of a jawbone 55, having a customizable dental implant system 30 implanted therein, between natural teeth 56. The customizable dental implant system 30 referenced herein and throughout the specification is described in a co-owned and pending PCT Application No. PCT/IB2012/053829 the contents of which are incorporated herein by reference as fully set forth herein.

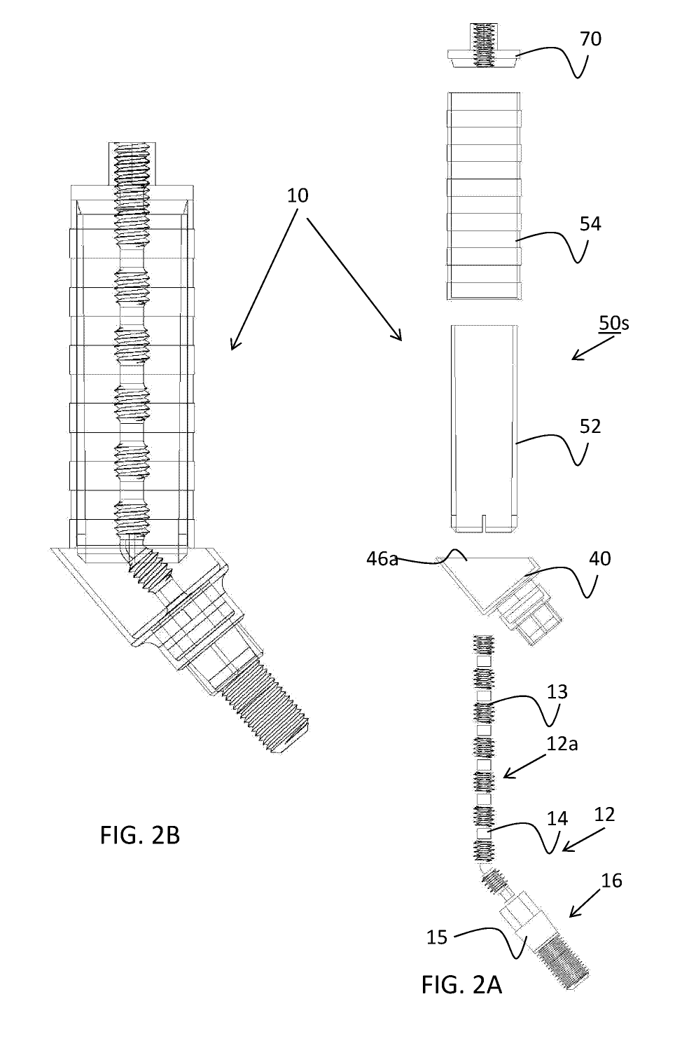

Adjustable dental implant system 30 comprises an implant anchor 32, prosthodontic restoration 5 and an abutment assembly 10. Most preferably a state of the art implant anchors 32 is provided to replace the native tooth root (apical end), while abutment assembly 10 and restoration 5 provide to replace the coronary portion of the tooth (occlusal end). Customizable dental implant system 30 is characterized in that it comprises an adjustable and/or customizable abutment assembly 10. FIG. 1 shows an implant system 30 after it has been customized and adjusted to account for the prosthodontic requirements with respect to the individual's morphology and/or clinical situation, so that the implant system 30 may properly fit with adjacent abutments and/or teeth and/or tissue. FIG. 2A-B shows the members of abutment assembly 10. Abutment assembly 10 may be formed from variable combinations of members including abutment pivot 12 having a pivot mounting member/portion 16 and occlusal portion 12a that form the core of abutment assembly 10. Abutment assembly 10 may further comprises, at least one or more members selected from the group consisting of a sleeve 50, sleeve assembly 50s, inner sleeve member 52, outer sleeve member 54, composite buildup about pivot occlusal portion 12a (not shown), an interface member 40, and a locking nut member 70 and locking member plug 72 (not shown), for example as shown in FIG. 2A-B.

Optionally and preferably any member or portion of an implant system and/or abutment assembly 10 may be adjusted and/or customized as necessary with dedicated tool 100 according to the present invention as described herein.

Optionally and preferably dental tool 100 according to the present invention may be utilized to customized and/or adjust any prior art dental implant system or portion thereof, or the like dental restoration system and is not limited to use with the adjustable abutment assembly 10.

Although the foregoing description provides characterizations of the dental tools according to the present invention with respect to adjustable abutment assembly 10, however, embodiments of the present invention are not limited to use with adjustable abutment assembly 10 and may equally be utilized as a standard dental tool with any implant anchor and/or implant restorative system.

Most preferably tool 100 is provided in the form of a cutting and/or milling and/or filing device provided to customize and/or adjust and/or configure a member of a dental implant system to meet the prosthodontic requirements with respect to the individual's morphology and/or clinical situation.

Optionally tool 100 provides for manipulating and/or adjusting and/or customizing a dental implant system member along any dimension for example including but not limited to height, width, diameter, length or any combination thereof.

Most preferably tool 100 provides for manipulating and/or adjusting and/or customizing a member of an optional dental implant system by performing and/or facilitating at least one or more of the following activities, for example including but not limited to cutting, excising, surfacing, leveling, scoring, slicing, routing, filing, sizing, shaping, milling, grinding, the like or any combination thereof.

Most preferably tool 100 a may be utilized to customize and/or adjust a state of the are abutment 11, any member of abutment assembly 10 (FIG. 2A-G, a state of the art implant anchor 32, or the like member of a dental implant system, so as to meet clinical situation and prosthodontic requirements to ensure that the implant process is successful and viable.

Optionally tool 100 may further provide for adjusting, by way of bending and/or aligning and/or positioning members of abutment assembly 10. For example, embodiments of tool 100 may provide for bending and/or positioning pivot 12a to ensure alignment of abutment 10 relative to residual teeth and/or other abutments on the same and opposite jaw, and surrounding tissue.

FIG. 2A shows an exploded view of an optional abutment assembly 10, that may be adjusted with tool 100. Abutment assembly 10 comprises abutment pivot 12 with an integrated pivot mounting member 16, interface member 40, sleeve assembly 50s comprising an inner sleeve 52 and an outer sleeve 54, and locking nut 70. FIG. 2B shows an assembled view of exploded view depicted in FIG. 2A showing an assembled abutment assembly 10 comprising an adjusted abutment pivot 12 and interface member 40. As shown at least one or more portions and/or members of a dental implant system, for example abutment assembly 10 may be adjusted with tool 100, to account for at least one or more prosthodontic requirements and/or parameters.

For example, pivot 12 may be adjusted, for example by way of bending, with tool 100 so as to obtain and assume any position to ensure alignment relative to residual teeth and/or abutments on the same and opposite jaw. Similarly tool 100 may be utilized to size and/or reduce the length of pivot 12 along portion 12a, by way of cutting, along an adjustment segment 13 or 14 for example.

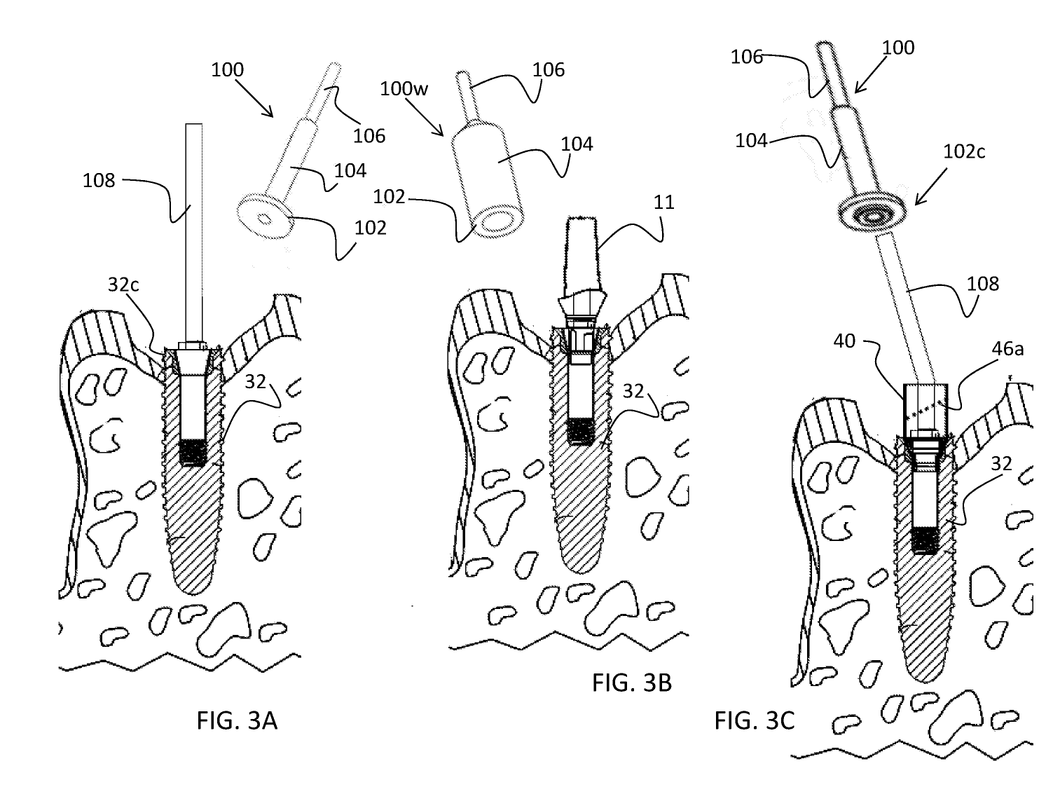

Optionally and preferably tool 100 may be utilized to customize interface member 40 so that it is properly sized and/or contoured according to the clinical situation at hand. As shown, tool 100 was utilized to define flange 46a forming a customized clinically optimized finishing line for the implant, as will be depicted in FIG. 3C.

Most preferably interface member 40 is adjusted with tool 100 with respect to the gingival tissue and in relation to pivot 12 to provide abutment 10, with the correct position and shape while conforming to the prosthodontic requirements, ensures that a restoration 5 is provided with proper alignment relative to residual teeth and/or abutments on the same and opposite jaw.

Most preferably an optional tool 100 provides for customizing Interface member 40 such that it is apically reduced by cutting and/or filing in relation to the alveolar bone, the gingiva, defining a finishing line 46a that is to be substantially perpendicular with respect to the adjusted abutment pivot 12 and substantially parallel to the occlusal plane.

Optionally interface member 40 may be adjusted according any specific clinical situation, and in any relation to the alveolar bone, and the gingiva regardless the position of pivot 12 and/or the occlusal plane.

Referring now to FIGS. 3-8 that show optional embodiments of tool 100 according to the present invention.

Most preferably tool 100 provides a milling, grinding and/or cutting tool providing for customizing and/or manipulating and/or adjusting at least one member of a dental implant system. Optionally tool 100 may be operated manually or with a dental hand piece as is known in the art.

Most preferably tool 100 comprises a head portion 102, body portion 104 and a handle portion 106. Most preferably head portion 102 is provided with at least one working surface or edge 100s, 100e provided to mill and/or cut the implant system member.

Optionally tool 100 may be used with a guiding member 108 provided to facilitate the customization process.

Optionally tool 100 may be associated with guiding member 108 along body portion 104 such that guiding member 108 forms an axis along which tool 100 may be utilized. Most preferably tool 100 and guide 108 are associated with on another such that the working surface 100s of head portion 102 is positioned perpendicularly to the axis formed by guiding member 108.

FIG. 3A-C show various uses of tool 100 according to optional embodiments in customizing optional dental implant members, FIG. 3A shows customization of anchor 32, FIG. 3B abutment 11, and FIG. 3C interface member 40 of abutment assembly 10.

FIG. 3A shows how tool 100 may be utilized with a guiding member 108 to customize anchor 32, for example including but not limited to a tissue level anchor or a bone level anchor, that is damaged along its coronal section 32c. For example, anchor 32 may be rendered non-functional by a crack or the like structural damage along its crestal portion 32c. The structural damage may be as a result of loss of substance, breakage, cracking or cleaving that renders the anchor non-functional.

Tool 100 may be utilized to save the implanted anchor 32 by filing down and/or apically reducing anchor 32 at its crestal portion 32c below the crack therein saving and/or restoring function of anchor 32.

Optionally and preferably tool 100 may be utilized with a guiding member 108 to provide a working axis along which tool 100 may operate.

Optionally guide member 108 may be associated with anchor 32, thereafter guide 108 may be adjusted as necessary, to assume the guiding axis for tool 100 so as to allow proper customization of anchor 32. Tool 100 is then associated over guide 108 so as to allow head portion 102 and in particular tooling surface 100s to mill anchor 32 at its crestal portion 32c at the correct angle and/or plane, according to the clinical situation and/or prosthodontic requirements.

Optionally tool 100 may be used to apically reduce anchor 32 about its crestal portion with 32c along the axis defined by guiding member 108, with a dental hand-piece (not shown) that is associated with handle 106. Optionally tool 100 may be used to apically reduce anchor 32 manually at portion 32c by manual manipulation of handle 106.

FIG. 3B shows another optional utilization of an optional milling tool 100, in the form of wide body tool 100w that is used to customize a state of the art abutment 11. Optionally and preferably abutment 11 is associated with tool 100 allowing working surface 100s to mill a portion of abutment 11, as is clinically necessary. Optionally tool 100w may be manipulate manually with handle 106 or with a dental hand-piece associated with handle 106.

FIG. 3C shows a further optional utilization of an optional milling tool 100 utilized to customize interface member 40 forming a part of abutment assembly 10, for example as shown in FIG. 2A-B. Optionally and preferably tool 100 is used to adjust and shape the rim of interface member 40 along line 46a to form a customized finish line 46a, as shown in FIG. 2B. Optionally a guiding member 108 (not shown) may be utilized to define the working axis for tool as previously described. Optionally a pivot 12 and in particular occlusal portion 12a, not shown, may be utilized and act as the guiding member 108.

Optionally and preferably when customizing an interface member 40 tool 100 may comprise a specialized head portion 102 shown in the form of concentric head portion 102c. Optionally and preferably concentric head portion 102c is configured to associate with the rim of interface member 40.

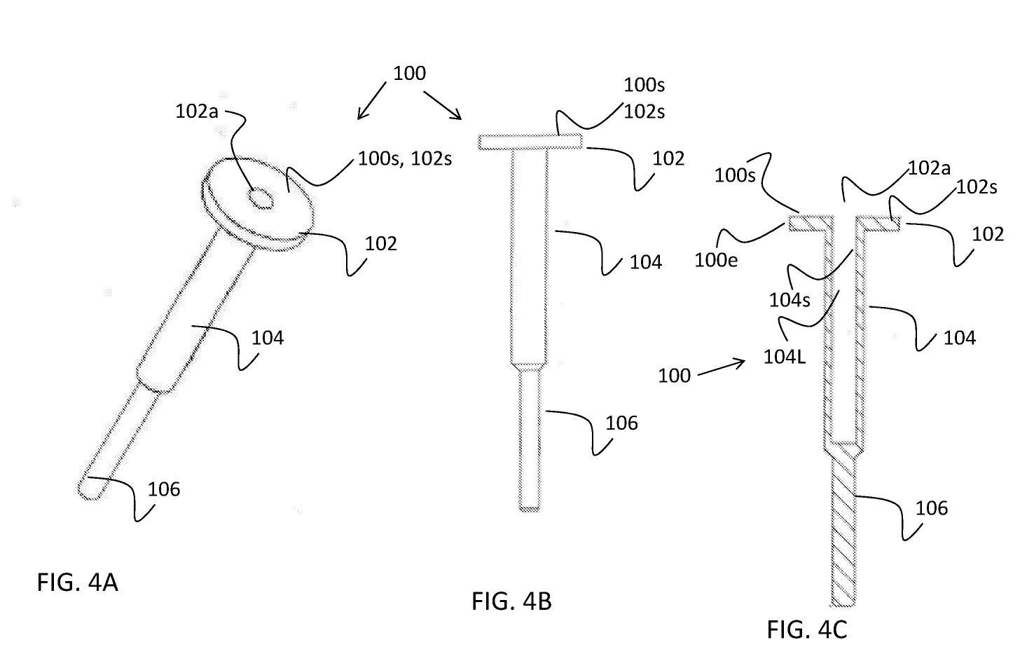

FIG. 4A-C show a detailed depiction of an optional tool 100 comprising a handle portion 106, a body portion 104 and a head portion 102, and at least one or more active/working surface or edge 100s, 100e.

Optionally tool 100 may be provided from a single continuous body comprising handle 106, body 104 and head portion 102, as shown.

Optionally tool 100 may comprise a body portion 104 that is fused and/or continuous with head portion 102 forming a single core body onto which a handle portion 106 may be coupled.

Optionally a unique milling tool 100 may be assembled and/or configured by coupling at least one or more portion members including a handle portion 106, a body portion 104, and head portion 102, from a variety of optional portions that may be fit and/or coupled with one another. Optionally and preferably coupling between the functional portions may be provided by a dedicated coupler for example including a male-female coupler or the like.

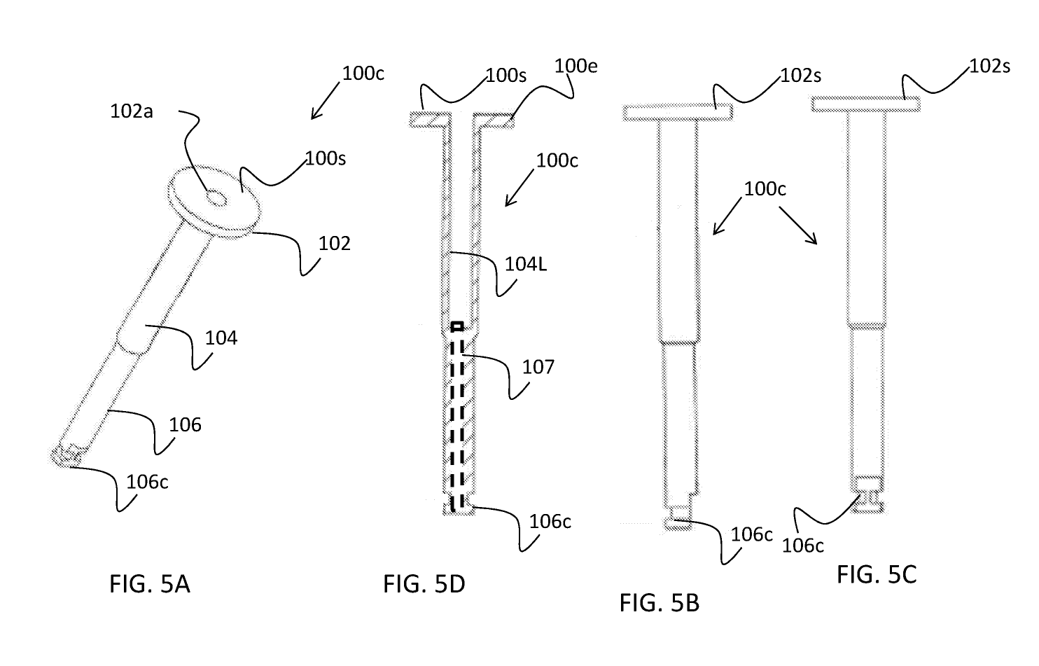

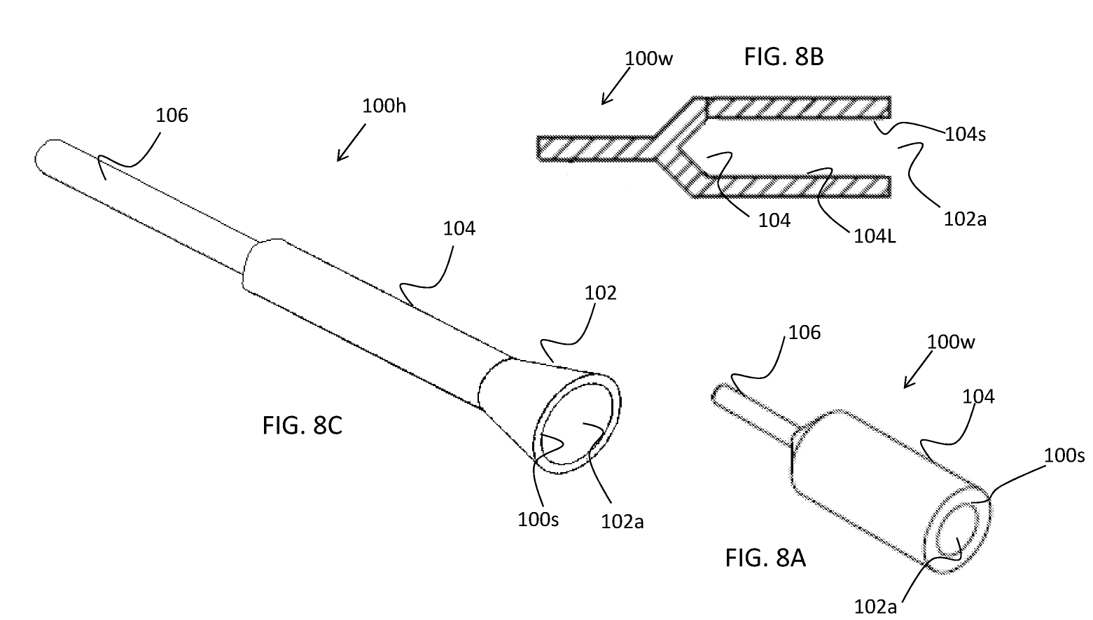

Optionally tool 100 may be customized and/or configured from at least two or more individual members including a head portion 102, body portion 104 and handle portion 106 that may be coupled or otherwise securely associated with one another to form an optional assembly of tool 100. For example a low speed handle portion 106 (FIG. 5A-D) may be coupled with a body portion 104 having a wide body (FIG. 8A-B), that may be further coupled to head portion 102 have conic profile (FIG. 8C).

Optionally tool 100 may further comprise a fluid exchange channel 107, for example as schematically shown in FIG. 5D. Optionally channel 107 may be disposed internally within handle 106 having an open end positioned facing and/or directed toward lumen body 104L, for example as shown in FIG. 5D. Optionally fluid exchange channel may be provided for ventilation and/or cooling tool 100 during its use. Optionally fluid exchange channel 107 may be utilized to provide for fluid exchange about a working surface 100s and/or edge 100e during use. For example channel 107 may be utilized for introducing a cooling flowing fluid such as water into lumen 104L for cooling working surface 100s and/or edge 100e while device 100 is rotating to continuously cool the working surface 100s.

Optionally fluid exchange channel may be provided about the external surface of any portion of tool 100 for example along handle 106 and/or body 104.

Optionally fluid exchange channel may be provided about the internal (luminal) surface of any portion of tool 100 for example along handle 106 and/or body 104 about luminal surface 104L. Optionally fluid exchange channel may be embedded with the wall of tool 100 about any portion of tool 100 for example including but not limited to along handle 106 and/or body 104, for example as shown in FIG. 5D.

Optionally fluid exchange channel may for example provided in the form of an irrigation channel to deliver a flowing fluid in the form of a liquid to the working surface 100s so as to cool the surface 100s while using tool 100. Optionally fluid exchange channel may be utilized to suction the working surface 100s during use, for example by evacuating air and/or debris during use of tools 100, so as to maintain a clear and cool working surface 100s.

Optionally and preferably tool 100 may be provided in any size and/or shape about any of its handle portion 106, body portion 104, or head portion 102.

Optionally a plurality of tool 100 of varying sizes may provide a kit thereof.

Optionally active working surface 100s and/or working edge 100e may be disposed about at least a portion of an external surface and/or at least a portion of an internal surface of body portion 104 or head portion 102. More preferably working surface 100s may be disposed about at least a portion of an internal surface 104s of body portion 104 about body portion lumen 104L and/or about at least a portion of the external surface 102s of head portion 102. Optionally and preferably working edge 100e may be disposed about an edge of head portion 102.

Most preferably working surface 100s and/or working edge 100e may be provided in the form of a coated surface that may be used to cut, file excise, surface, level, score, slice, route, size, shape, the like or any combination thereof. Optionally surface 100s and/or edge 100e may be coated with any abrasive or sanding material for example including but not limited to diamonds, diamond dust, sandpaper, glass, silicone, carbon coated steel, any metals any combination thereof or the like. Optionally surface 100s and/or edge 100e may be coated with a combination of abrasive or sanding materials in optional ratios and/or proportion along working surface 100s and/or edge 100e. For example, an inner portion of surface 100s may be coated with carbon coated steel while an outer portion of surface 100s may be coated with diamond dust. Optionally the ratio, proportion and materials utilized over surface 100s may be determined based on the implant system member being filed and the materials it comprises.

Optionally the working surface may be coated with at least two different abrasive materials having different milling and/or filing and/or material properties.

Most preferably tool 100 is rotated about handle 106, manually or by machine, to form a rotating, coated working surface, that in turn acts as a cutting and/or shaping and/or filing surface to facilitate adjusting at least one member of implant system 30 and/or abutment assembly 10.

FIG. 3A-C shows various views of a schematic illustration of an optional tool 100 provided for cutting, excising, surfacing, leveling, scoring, slicing, routing, filing, sizing, shaping, or any combination thereof, at least a portion of abutment assembly 10.

FIG. 4A shows a perspective view of tool 100 while FIG. 4B provides a face on view. Optionally handle portion 106 may be customized to facilitate manipulating and/or working tool 100 in a plurality of manners for example including but not limited to manual operation or machine operation.

Optionally handle 106 may be configured and/or customized to facilitate machine operation of tool 100 by coupling to a motorized tool or auxiliary device (not shown) for example including but not limited to a dental drill, dental hand-piece, milling machine, or the like motorized tool. Optionally handle 106 may be customized to facilitate manipulation at variable speeds.

Optionally handle 106 may be customized to facilitate manual operation wherein handle 106 may be provided with an ergonomic, user friendly design. Optionally handle 106 may be customized to couple with auxiliary manual tools for example including but not limited to an elongated handle, ratchet handle, torque handle or the like. Optionally an auxiliary elongated handle may be provided to facilitate creation of sufficient torque moment.

Optionally handle 106 may be configured and/or adapted for operation under variable speed manipulation, for example including but not limited to low speed, high speed, manual speed or any combination thereof. For example, FIG. 4A-C show a handle portion 106 provided for high speed manipulation with a standard dental hand-piece, while FIG. 5A-D show handle portion 106 adapted for low speed use with a standard dental hand-piece.

Optionally handle portion 106 may be further fit with a coupling member 106c, for example as depicted in FIG. 5A-D, to facilitate coupling to a manual auxiliary or motorized auxiliary device or the like auxiliary device. Optionally and most preferably coupler member 106c is customized according to the required auxiliary device.

Most preferably body portion 104 is substantially an elongated hollow cylindrical portion of tool 100, having a lumen 104L, FIG. 4C. Most preferably lumen 104L provides for receiving an optional guiding member 108 and/or housing a member of abutment assembly 10, for example pivot 12 and/or optional sleeve 50,52,54,50s. Lumen 104L provides for associating tool 100 with a guiding member 108 allowing the guiding member to define the working axis for tool 100 during use. By way of receiving optional guiding members 108 lumen 104L further facilitates ensuring that the working surface 100s,100e is positioned perpendicularly to the working axis defined by the guiding member 108.

For example, as described in FIG. 3C, while adjusting the surface of interface member 40 about flange 46 to form flange 46a (finish line), lumen 104L provides for receiving and housing pivot 12 and/or a sleeve member 50 and/or a guide member 108 most preferably providing for ensuring that flange 46a is substantially perpendicular to pivot 12 and/or sleeve member 50 and/or guide 108.

Optionally body portion 104 may be provided in any size and/or shape to facilitate manipulation and or working any portion of an implant system 30 and/or abutment assembly 10. For example the body portion 104 may be provided in wide configuration as shown in FIG. 8A-B.

Optionally lumen 104L may comprise a working surface 100s about its internal surface 104s. Optionally working surface 100s may be disposed about at least a portion of lumen 104L. Optionally working surface 100s disposed about the internal surface 104s of lumen 104L in any location, pattern or shape, for example including but not limited to continuous, intermittent, midway, adjacent to head portion, adjacent to handle portion, any combination thereof or the like.

Most preferably head portion 102 comprises an external surface 102s comprising a bore and/or recess 102a defining the opening to lumen 104L, that is provided for receiving optional members of implant system 30 and/or abutment assembly 10 to be adjusted, and/or a guiding member 108. Most preferably recess 102a may be continuous with body portion lumen 104L and therein forming an opening for lumen 104L.

Optionally and preferably head portion 102 is continuous with and extends from body portion 104. Most preferably head portion 102 is configured to be perpendicular with respect to body portion 104 such that head portion 102 including working surface 100s is position at 90 degree to lumen 104L.

Most preferably head portion 102 is a disc and/or ring shaped member comprising at least one or more working surface 100s and/or working edge 100e, for example as shown.

Most preferably head portion 102 external surface 102s serves as the working surface 100s of tool 100.

Most preferably head portion 102 may be provided in a number of optional configurations, shapes and/or sizes. Optionally and preferably the shape of head portion 102 may be determined by the dimension and/or size of the member of implant system 30 and/or abutment assembly 10 that is being adjusted. For example adjustment of a sleeve member 50 and/or interface member 40 may require a larger head portion 102 size than when adjusting pivot 12.

Optionally head portion 102 may be provided with optional shape for example including but not limited to conic, inverted cone, concentric, cylindrical, ring, circular, spheroid, semicircular, or the like.

Optionally head portion 102 having a conic shape and comprising a lumen, for example as shown in FIG. 8C.

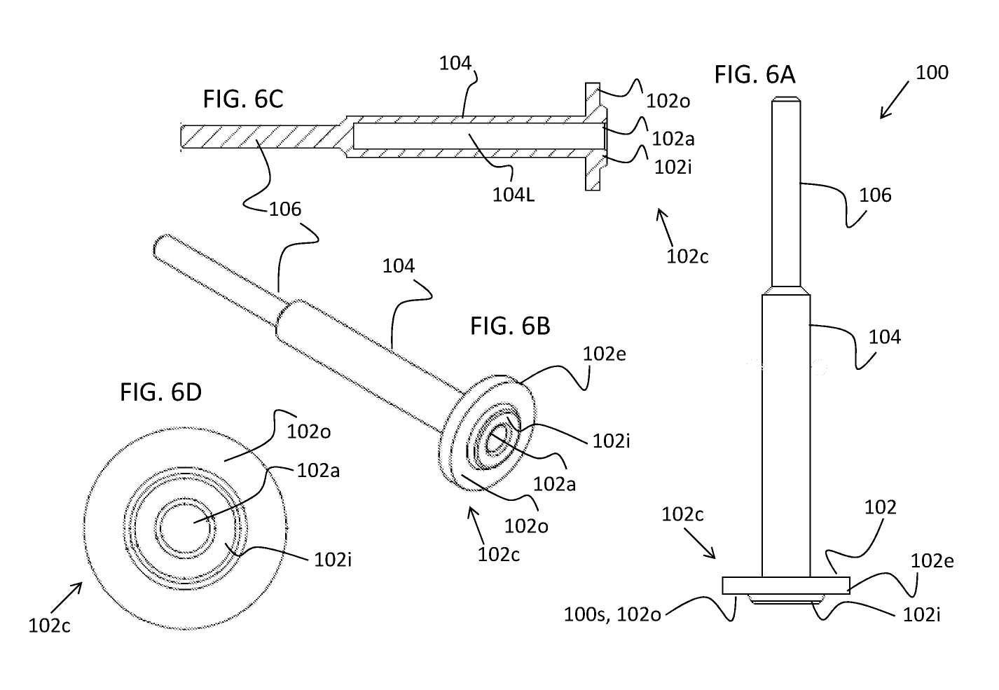

Head portion 102 may comprise a concentric configuration as shown in FIG. 6A-D where head portion is provided

Most preferably tool 100 is utilized such that working surface 100s and/or working edge 100e are provided with a diamond coating and/or the appropriate filing material as is known in the art. Optionally working surface and/or edge 100s,100e may be provided form a plurality of materials so as to form a gradient of materials.

FIG. 5A-D show various views of tool 100c of an optional embodiment similar to that depicted in FIG. 3A-C, where tool 100c is provided for coupling with an auxiliary hand-piece dental tool about a handle coupling member 106c customized for low speed use.

FIG. 6A-D show various views of tool 100, comprising a head portion 102 defined as a concentric head portion 102c. Most preferably concentric head portion 102c is shaped provides for fitting within the lumen of an interface member 40, for example as shown in FIG. 3C. Preferably concentric head portion 102c comprise a surface having an outer portion 102o defining the working surface 100s and an inner portion 102i that defines a raised rim extending from outer surface 102o. Preferably the size and dimension of inner portion rim 102i is configured so as to facilitate fitting within the lumen of interface member 40. FIG. 6A-C show varying perspective and side view of tool 100 depicting head portion 102c having a concentric configuration. FIG. 6D shows a face on view of head portion 102c showing it concentric configuration as previously described.

FIG. 8A-B shows an optional embodiment of tool 100 shown in the form of wide body tool 100w wherein head portion 102 and body portion 104 are continuous with one another, forming a single body portion 104 with a wide lumen 104L.

FIG. 8C shows an optional embodiment of tool 100 in the form of conic head tool 100h where head portion 102 is provided in the form of a conic section comprising a working surface 100s about the internal surface of conic head section 102. Optionally tool 100h may facilitate shaping and/or customizing and providing an angled surface about an edge of a sleeve member 50, or interface member 40 or the like member of implant system 30 or abutment assembly 10.

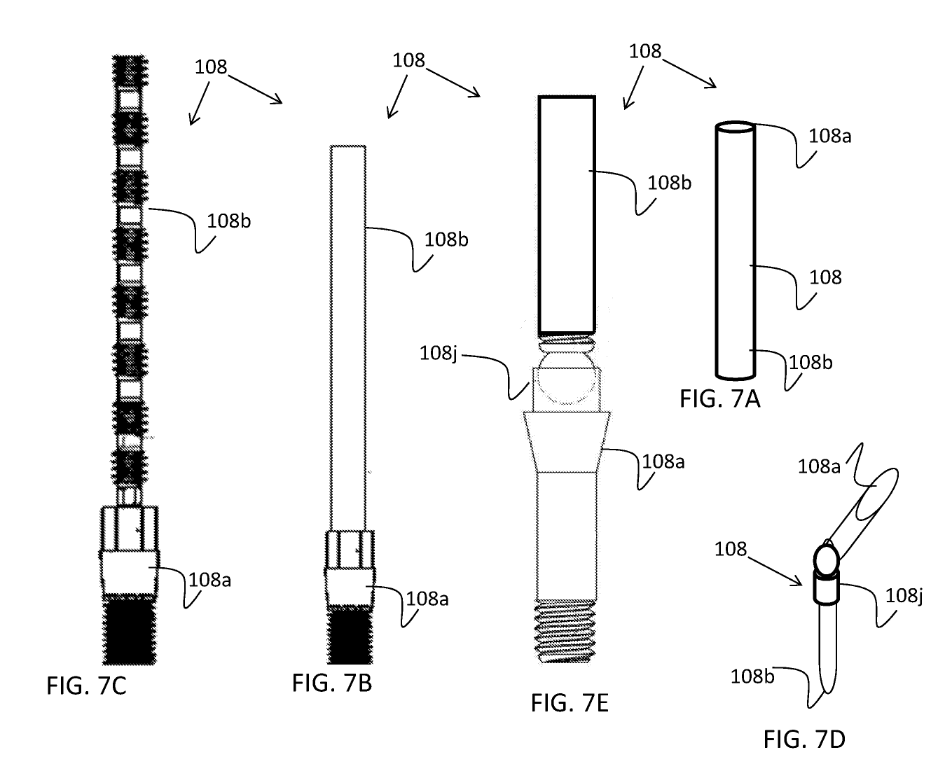

FIG. 7A-E shows a schematic illustration of optional guiding members 108 having a substantially cylindrical body and comprising a first end 108a and a second end 108b. Optionally and preferably the operation of cutting tool 100 may be facilitated with guiding member 108. Optionally guiding member 108 provides to facilitate proper positioning of the tool 100, therein forming a working axis for tool 100 relative to the implant system member to be adjusted. Optionally guiding member 108 may be associated with an implant system member at a first end 108a and/or associated with the tool 100 at a second end 108b.

For example first end 108a may be associated with an implant anchor 32, for example by way of threading snaps connectors, pressure fit connectors, Morse angle or the like, and introduced second end 108b to lumen 104L of tool 100 via receiving bore 102a, such that the axis of guiding member 108 acts as a guide and/or working axis for tool 100 during its use.

Optionally guiding member 108 may be adjusted and/or configured and/or shaped as needed to provide tool 100 with the proper working axis that is preferably substantially perpendicular with the occlusal plane.

Optionally guiding member 108 may be adjusted and manipulated along its length in order to assume a plurality of optional shapes and/or contours. Optionally a properly shaped guiding member 108 enables tool 100 to assume the proper orientation prior to its use. Optionally guiding member 108 may be provided from malleable materials for example including but not limited to metals, alloys, polymers or the like.

Optionally guiding member 108 may be provided from a plurality of members disposed about its length between 108a with at least one or more elements that may be adjusted relative to one another for example a joint, ball and socket joint 108j, interlinked members, or the like. For example, FIG. 7D-E show optional guiding members 108 as previously described further comprising a joint member 108j, schematically depicted as a ball and socket joint.

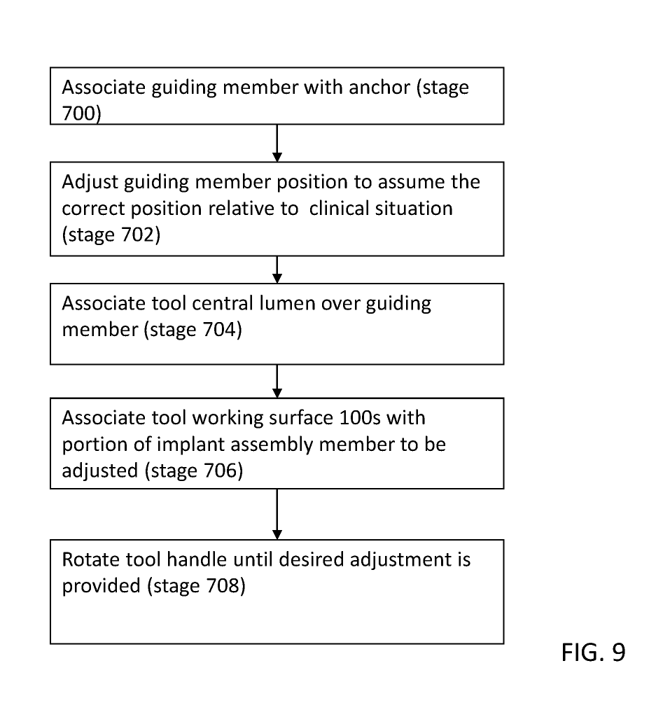

FIG. 9 shows a flowchart depicting an optional method of using tool 100 to adjust at least a portion of an implant system.

First in stage 700 a guiding member 108 and/or an abutment pivot 12 are associated with an anchor 32. Next in stage 702 guiding member 108 and/or abutment pivot 12 is positioned to assume the correct position relative to clinical situation.

Next in stage 704, tool central lumen 104L is associated over guiding member 108. Next in stage 706 the working surface or edge 100s, 100e disposed on head portion 102 is brought into contact over the portion of the implant system that is to be adjusted and/or customized and/or milled.

Finally in stage 708 handle 106 is activated to rotate working surface 100s, 100e either manually by a user or via a dental hand-piece. The adjustment is continued until the desired shape and/or customization is achieved.

In some embodiments stage stages 700, 702 and 704 may be optional if a guiding member 108 is not required to create a working axis for tool 100, for example as shown with FIG. 3B where portions of abutment 11 forms the working axis for tool 100.

Those skilled in the art to which the presently disclosed subject matter pertains will readily appreciate that numerous changes, variations, and modifications may be made without departing from the scope of the invention, mutatis mutandis.

While the invention has been described with respect to a limited number of embodiment, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not described to limit the invention to the exact construction and operation shown and described and accordingly, all suitable modifications and equivalents may be resorted to, falling within the scope of the invention.

While the invention has been described with respect to a limited number of embodiments, it will be appreciated that many variations, modifications and other applications of the invention may be made.

1. A dental tool (100) provided for milling and/or filing portions of a dental implant system, the device (100) having at least one working surface (100s), the device comprising:
a. a head portion (102) having a surface (102s) defining a working surface (100s), said working surface (100s) forming an abrasive surface, said surface (102s) having a central bore (102a);
b. a tool body portion (104) that is substantially a hollow tube having a central lumen (104L), said central lumen (104L) is continuous with said central bore (102a), characterized in that said lumen (104L) is configured to receive and house a guiding member (108); and
c. a handle portion (106) extending from said body portion provided to facilitate rotating device (100) and said at least one working surface (100s).

2. (canceled)

3. (canceled)

4. (canceled)

5. The device of claim 1 further comprising a working surface (100s) disposed on at least one of the internal surface (104s) of said lumen (104L) and the internal surface (104s) of said borehole (102a).

6. The device of claim 1 wherein said working surface is disposed about at least one surface of said head portion or said body portion.

7. The device of claim 6 wherein said working surface is disposed along at least one of: an external surface, edge, an internal surface, any combination thereof.

8. The device of claim 1 wherein at least a portion of the internal surface of said body portion lumen (104L) having an abrasive material forming a working surface.

9. (canceled)

10. (canceled)

11. The device of claim 1 wherein said device (100) is provided for manipulating and/or adjusting at least one member of a dental implant system selected from the group consisting of an implant anchor, implant abutment, sleeve, a member of an adjustable abutment assembly (10), interface member (40), abutment pivot (12), pivot mounting member (16), abutment occlusal portion (12a), sleeve (50), sleeve assembly (50s), inner sleeve member (52), outer sleeve member (54), locking nut (70), any combination thereof.

12. (canceled)

13. The device of claim 1 wherein said working surface provides for at least one or more of: cutting, excising, surfacing, leveling, scoring, slicing, routing, filing milling, grinding, sizing, shaping, or any combination thereof.

14. The device of claim 1 wherein said handle portion is configured to facilitate working said device manually by a user.

15. The device of claim 1 wherein said handle portion is configured to be coupled to a motorized auxiliary device for working said device and wherein said motorized auxiliary device is selected from a dental drill, dental hand-piece and a milling machine.

16. (canceled)

17. The device of claim 1 wherein said handle portion is customized to be coupled to a manual auxiliary device for working said device wherein said manual auxiliary device is selected from the group consisting of an elongated handle and a ratchet handle.

18. (canceled)

19. The device of claim 1 wherein said handle portion further comprises a connector and wherein said connector is configured for filing and/or milling according to the filing and/or milling speed, selected from the group consisting of low speed, high speed, manual speed or any combination thereof.

20. (canceled)

21. (canceled)

22. The device of claim 1 wherein said head portion (102) is provided with optional shape selected from the group consisting of discoid, conic, cylindrical, ring, circular, spheroid, semicircular, concentric disc, layered disc.

23. (canceled)

24. (canceled)

25. (canceled)

26. The device of claim 1 further comprising a fluid exchange channel.

27. (canceled)

28. The device of claim 1 wherein said device may be assembled from three individual portions that are coupled with one another, including at least one of a handle portion, a body portion and a head portion to form a single unitary continuous milling tool.

29. (canceled)

30. (canceled)

31. (canceled)

32. (canceled)

33. A system for milling and/or filing portions of a dental implant system the system including a device according to any of claims 1-31 and a guiding member (108) configured to associated with said milling device over said lumen (104L) through said bore (102a) and wherein said guiding member provides for defining the working axis for said milling device.

34. (canceled)

35. The system of claim 33 wherein said guiding member (108) is adjustable along its length providing for defining a working axis for said device (100).

36. (canceled)

37. (canceled)

38. A method for in-situ chair-side milling and/or filing of portions of at least one member of a dental implant system with the system of claim 33, the method comprising:
a. associating a guiding member (108) with an implant anchor (32) at a first end (108a);
b. adjusting at least one of the position, length, angle of said guiding member (108) to define a working axis for device (100) wherein the axis is substantially perpendicular to the occlusal plane;
c. associating said device (100) over the second end (108b) of said guiding member (108) wherein working surface (100s) is brought into contact with the milling site at the angle defined by the working axis; and
d. rotating device (100) by manipulating handle (106) to mill a portion of said dental implant system at the milling site.

39. (canceled)

40. The method of claim 33 adapted to mill an interface member (40) with a device (100) comprising a concentric head portion (102c) and guiding member (108).

41. The method of claim 33 adapted to mill a bone level implant anchor (32) or a tissue level implant.

42. (canceled)

43. The device of claim 1 wherein said abrasive surface is configured to have an abrasive material or coating selected from the group consisting of diamonds, diamond dust, sandpaper, glass, silicone, carbon coated steel, metals, alloys, any combination thereof.
